(19) United States
(12) Patent Application Publication
(10) Pub. No.: US 2009/0159801 A1
(43) Pub. Date: Jun. 25, 2009

(54) Fluorescence optical coatings and methods for producing same

(75) Inventors: Jamie Knapp, Mendon, MA (US); Michael R. Carta, Northborough, MA (US)

Correspondence Address: Brian F. Swienton;Newport Corporation, 1791 Deere Avenue, Irvine, CA, 92606, US

(73) Assignee: Newport Corporation, Irvine, CA (US)

(21) Appl. No.: 12/004,599

(22) Filed: Dec. 21, 2007

(51) Int. Cl. G01T 1/20; B32B 9/04

(52) U.S. Cl. 250/363.01; 428/411.1; 428/336; 428/690

(57) ABSTRACT

Fluorescence coatings and methods for applying such coatings are provided wherein the coatings can be applied, by way of example, to the window of the housing of an optoelectronic device, thus enabling the coatings to eliminate the need for one or both of an excitation optical filter and an emission optical filter that normally form a portion of the fluorescence equipment that is utilized in furtherance of fluorescence detection and/or measurement applications.

### BACKGROUND

Recently, there has been increased usage of fluorescence-based measurement and detection techniques in connection with a wide range of biomedical applications such as new drug discovery, DNA and RNA sequencing, investigation and detection of medical conditions, molecular and cellular biology, toxicology, and blood analysis, to name a few. In furtherance of such techniques, one selects a fluorophore (i.e., a dye) that is designed to respond to a specific spectral excitation and adds the fluorophore to a biological specimen or sample. The specimen is then excited (e.g., via a high intensity light source) and a detector or sensor is used to detect the fluoresced light, which has a longer wavelength and a lower energy/intensity than the excitation light.

Fluorescence techniques are highly advantageous in that they often provide measurement and detection options that are vastly improved as compared to what was previously the state of the art. Take, for example, breast cancer detection. Prior to the advent of fluorescence techniques, the standard breast cancer detection option was mammography, which tended to reliably identity only sizeable tumors that had been growing for some time. Now, however, one can test for breast cancer through use of fluorescence techniques that detect cancerous cells, even those that may not have formed a tumor visible via mammography.

Current fluorescence techniques employ instruments such as flow cytometers, microplate readers, spectrometers and microscopy systems. Such instruments generally include an excitation light source, two spectrally isolating optical filters to discriminate emission photons from excitation photons, and a device for optically detecting or sensing the emitted photons. For example, FIG. 1 schematically depicts a conventional fluorescence spectrometer 100 in which light 102 from a light source 104 having a window 105 passes through a discreet excitation optical filter 106 and then is directed (e.g., via an optional dichroic mirror 110) to the biological sample 108 that is under measurement and to which a fluorophore has been added. The resultant emitted light 112 passes through a discreet emission optical filter 114 and is measured by a sensor/detector 116 having a window 117.

During use of fluorescence instrumentation such as that which is depicted in FIG. 1, only light 112 of very small intensity tends to be emitted from the examined specimen. For example, it is not unusual for the emitted light 111 to be less intense than the excited light 102 by six or seven orders of magnitude. As such, and due to the significance of the fluorescence processes involved, it is necessary to use high quality equipment to ensure that proper measurement/detection occurs. These factors, plus others (e.g., close spectral proximity of excitation/emission center wavelengths), demand the use of high performance optical filter pairs 106, 114 capable of isolating the low-intensity emitted light 112 from the high-intensity excited light 102. In fact, to function adequately, optical filters 106, 114 generally are required to exhibit various properties such as (1) high signal-to-noise for the light source 104 and detector 116, (2) high signal-to-noise for the wavelengths of maximum absorption/emission (i.e., low cross talk), and, for the emission filter 114, (3) high energy throughput.

At present, there are three general types of optical filters that are used as excitation and emission optical filter pairs 106, 114. Unfortunately, in order to possess/exhibit the aforementioned properties, each of the three types of filters 106, 114 is required to be quite large in size, such as 1 inch in diameter or greater. This large size requirement renders production of the optical filter pairs 106, 114 costly and exacting regardless of the specific manufacturing process selected.

The three general types of excitation and emission optical filters 106, 114 are illustrated in FIGS. 2-4. In FIG. 2, the depicted filter 200 consists of multiple sheets or substrates 202, 204, 206, 208 of optically coated glass. Thin film coatings 210, 212 can be applied to all or, as shown in FIG. 2, some of the interior and/or exterior surfaces of the substrates 202, 204, 206, 208. Once the selected surface(s) of the substrates 202, 204, 206, 208 have been coated as desired, the substrates are laminated together via an optically transparent epoxy (not shown) to form the filter 200.

There are two specific problems with optical filters 200 having a design as shown in FIG. 2, both relating to the epoxy used for lamination. First, the epoxy can melt at temperatures above about 125° C., which can be encountered during normal use of some light sources 104. And once the epoxy is melted to a certain extent, the substrates can become delaminated, thus rendering the filter(s) 200 unsuitable for use. Second, ultraviolet light can cause the epoxy to degrade and darken, thus diminishing the accuracy of the measurement or detection processes that rely upon the filter(s) 200.

FIG. 3 depicts an embodiment of U.S. Pat. No. 6,918,673 to Johnson et al., the entirety of which is incorporated by reference. The FIG. 3 embodiment does not utilize an epoxy, instead providing a filter 300 that is formed from a plurality of discreet glass substrates 302, wherein thin film coatings 304 have been applied to the interior surfaces of the substrates, and wherein an air gap 306 is defined between the coated interior surface of each substrate. The coatings 304 are highly environmentally sensitive; thus, the substrates 302 are held together by a ring 308, which creates a hermetic seal that serves to protect the coatings from environmental exposure.

Among the specific problems with regard to the FIG. 3 embodiment are that the filter 300 must be carefully manufactured to ensure that the seal is maintained intact throughout the lifetime of the filter. Moreover, heat (e.g., from a light source 104) can cause the air gap 306 to expand to an extent that the seal is compromised, and, in turn, the filter 300 becomes unsuitable for reliable use in furtherance of fluorescence techniques.

Lastly, FIG. 4 depicts an embodiment of U.S. Pat. No. 6,809,859 to Erdogan et al., the entirety of which is incorporated by reference. The FIG. 4 embodiment consists of a filter 400 formed by a single glass substrate 402 that has been separately coated on both its exterior surfaces with a multi-layer coating 404. This filter 400 is advantageous as compared to the filters 200, 300 in that it does not rely upon an epoxy, nor does it include an air gap or seal. Nevertheless, the filter 400 of FIG. 4 is highly complex and costly to manufacture, and still must be quite large in order to function properly as part of fluorescence equipment, e.g., as one or both of the optical filters 106, 114 that are utilized within the fluorescence spectrometer 100 shown in FIG. 1.

Thus, a need exists for an alternative to the excitation and emission optical filters that are currently used in connection with conventional fluorescence measurement and detection instruments, equipment and techniques, wherein this alternative not only avoids or at least minimizes the general and specific drawbacks associated with the conventional excitation and emission optical filters, but it also improves (e.g., with respect to cost, implementation and/or footprint) conventional fluorescence instruments, equipment and techniques that generally incorporate such filters.

### SUMMARY

The various devices and methods that are described in the present application meet these and other needs through use of one or more coatings that replicate the performance of, and thus negate the need for excitation and/or emission optical filters.

In one embodiment, an optoelectronic device has a housing, which has an outer surface (e.g., a transparent window). At least a portion of the outer surface of the housing is coated with a coating, which comprises at least one layer of at least one thin film material and is effective to at least substantially replicate the performance of a predetermined fluorescence optical filter (e.g., an emission optical filter or an excitation optical filter).

In accordance with such an embodiment, and, if desired, with other embodiments, the coating has a total layer thickness in the range of about 5 nm to about 10000 nm. Moreover, each of the at least one layer of the coating can have a thickness, for example, in the range of about 5 nm to about 1000 nm.

Also in accordance with such an embodiment, and, if desired, with other embodiments, the coating can have multiple layers formed of different materials. For example, the coating can comprise a plurality of layers, wherein a first of the plurality of layers is comprised of a first thin film material and a second of the plurality of layers is comprised of a second thin film material, and wherein the first thin film material is different than the second thin film material. If desired, the coating can be formed of alternating layers of the first and second thin films materials. Moreover, the coating can comprise at least three layers, wherein a first of the at least three layers is comprised of a first thin film material, a second of the at least three layers is comprised of a second thin film material, and a third of the at least three layers is comprised of a third thin film material, and wherein the first material is different than each of the second material and the third material, and wherein the second material is different than the third material. Whether the coating is formed of one layer or more than one layer, any of such layer(s) can be comprised of a combination of at least two different thin film materials.

Still also in accordance with such an embodiment, and, if desired, with other embodiments, one or more of the at least one layer of the coating can be comprised of a metal oxide material (e.g., silicon dioxide, niobium oxide, titanium oxide, hafnium oxide, tantalum pentoxide), or a combination of one or more of such metal oxide materials.

In another embodiment, a fluorescence measurement or detection apparatus (e.g., a fluorescence spectrometer) comprises (a) a light source that has a housing, which has an outer surface and (b) a detector that has a housing, which has an outer surface. At least one of the outer surface of the light source and the outer surface of the detector is at least partially coated with a coating that is comprised of at least one layer of at least one thin film material, wherein the coating is effective to at least substantially replicate the performance of a predetermined fluorescence optical filter (e.g., an emission optical filter or an excitation optical filter).

In yet another embodiment, a coating comprises at least one layer of at least one thin film material, wherein the coating is effective to at least substantially replicate the performance of a predetermined fluorescence optical filter (e.g., an emission optical filter or an excitation optical filter).

Still other aspects, embodiments and advantages of the present application are discussed in detail below. Moreover, it is to be understood that both the foregoing general description and the following detailed description are merely illustrative examples of various fluorescence coatings and methods of their formation, and are intended to provide an overview or framework for understanding the nature and character of the claimed subject matter. The accompanying drawings are included to provide a further understanding of the various embodiments of the fluorescence coatings and methods described herein, and are incorporated in and constitute a part of this specification.

### BRIEF DESCRIPTION OF THE DRAWINGS

For a fuller understanding of the nature and desired objects of the various embodiments of the fluorescence coatings and methods of manufacture/formation as described herein, reference is made to the following detailed description, which is to be taken in conjunction with the accompanying drawing figures wherein any like reference characters denote corresponding parts throughout the several views presented within the drawing figures, and wherein:

FIG. 1 is a schematic front view of a conventional fluorescence spectrometer;

FIG. 2 is a schematic side, perspective view of an exemplary optical filter for use in fluorescence equipment such as the spectrometer of FIG. 1;

FIG. 3 is a schematic side view of another exemplary optical filter for use in fluorescence equipment such as the spectrometer of FIG. 1;

FIG. 4 a schematic side, perspective view of yet another exemplary optical filter for use in fluorescence equipment such as the spectrometer of FIG. 1;

FIG. 5 is a schematic side view of an exemplary embodiment of the present application in which the window of a housing of an optoelectronic device has been coated with a fluorescence coating;

FIG. 6 is an enlarged schematic side view of the coated window of FIG. 5;

FIG. 7 is a front view of a schematic depiction of a method for applying a fluorescence coating onto the window of the housing of one or more optoelectronic devices in furtherance of the present application;

FIG. 8 is a graph of transmittance versus wavelength for a exemplary excitation-type fluorescence coating in accordance with the present application;

FIG. 9 is a graph of optical density versus wavelength for an exemplary excitation-type fluorescence coating in accordance with the present application;

FIG. 10 is a graph of transmittance versus wavelength for a exemplary emission-type fluorescence coating in accordance with the present application;

FIG. 11 is a graph of optical density versus wavelength for an exemplary emission-type fluorescence coating in accordance with the present application; and

FIG. 12 is a schematic front view of the fluorescence spectrometer of FIG. 1 without the presence of optical filters due to the housings of the light source and the photosensor having been coated with a fluorescence coating in accordance with the present application.

### DETAILED DESCRIPTION

The present application discloses fluorescence coatings and methods of applying, depositing or otherwise placing such coatings on target surfaces. In an exemplary embodiment, the target surface(s) are the transparent window(s) of the housing one or more optoelectronic devices, but it is understood that other objects can serve as one or more of the target surfaces in addition to or in lieu of the housing window(s).

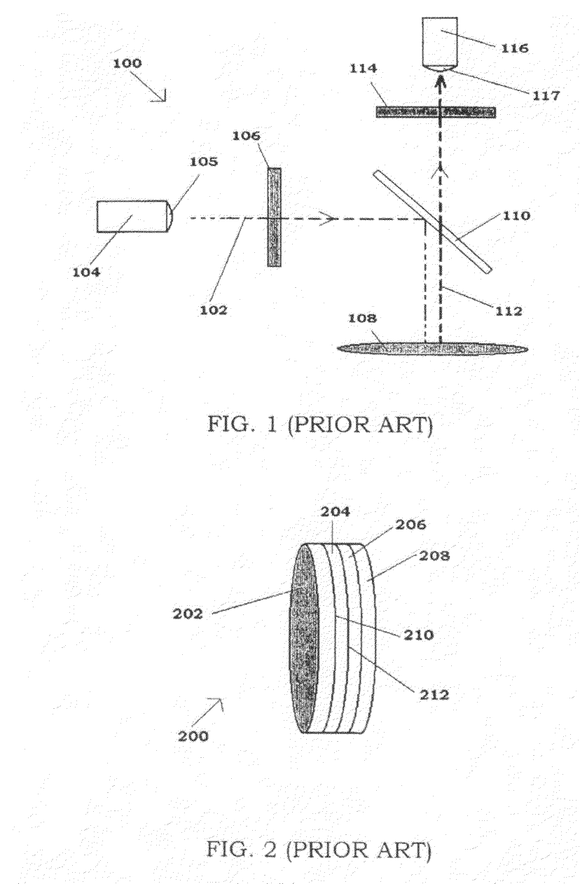

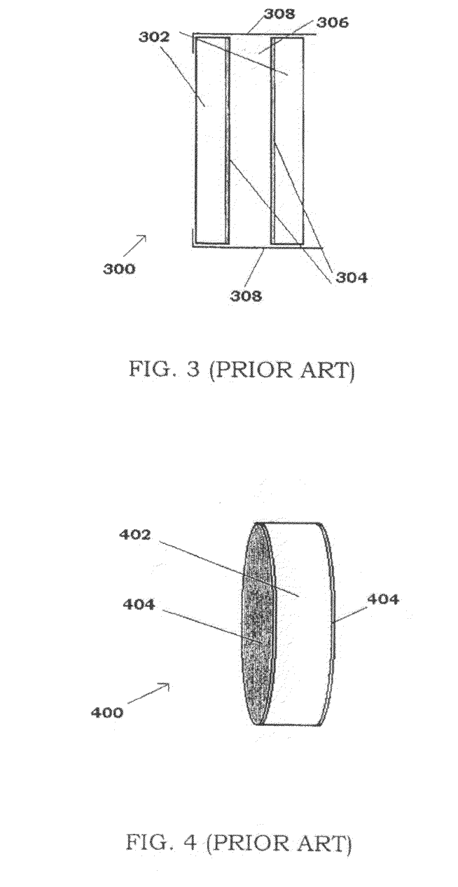

The applied fluorescence coating can perform the functions of optical filters, which, as exemplified by the optical filters 106, 114 depicted in FIG. 1, normally are required to be utilized in furtherance of conventional fluorescence techniques. Consequently, usage of the fluorescence coatings of the present application enables fluorescence techniques to be performed without one or both of the excitation and emission optical filters being present, thus providing various advantages (e.g., cost savings, reduction in the footprint occupied by the equipment) without any accompanying decrease in the ability to perform the fluorescence techniques, or by any decrease in the reliability of the measurement or detection that is normally provided in furtherance of such techniques.

The fluorescence coatings in accordance with the present application are single surface, multilayer coatings. Each layer of the coating generally is formed of a thin film material (e.g., a layer of material having a thickness in the range of about 5 nm to about 1000 nm, or within any and all subranges therebetween), wherein each coating layer can be comprised of the same, or, as is currently preferred, different materials. The layers of different materials can be alternating, such as in an A, B, A, B, etc. arrangement. Optionally, the coating may be formed from a single layer of a thin film material having a thickness in the range of about 5 nm to about 10000 nm, including any and all subranges therebetween.

Examples of suitable thin film materials from which the fluorescence coating layers can be entirely or partially formed include, but are not limited to, one or more oxide materials, such as metal oxides or combinations (i.e., alloys) of two or more metal oxides. Suitable such metal oxides include, but are not limited to, silicon dioxide (SiO₂), niobium oxide (Nb₂O₅), titanium oxide (TiO₂), hafnium oxide (HfO₂) and tantalum pentoxide (Ta₂O₅). In an exemplary embodiment of the present application, the fluorescence coating is comprised of two or more different metal-oxide materials, wherein each coating layer is comprised of either a single metal-oxide material or a combination (i.e., alloy) of two or more metal oxide materials.

The fluorescence coating can be applied, deposited or otherwise placed onto the target surface(s) via one or more of various techniques. However, in accordance with one exemplary embodiment, the specific coating application technique is selected so as to result in an applied fluorescence coating that is permanent, resistant to/against the effects of the environment, and that does not spectrally shift upon exposure to varying temperature and/or humidity conditions. Exemplary suitable such application techniques for the fluorescence coating include, but are not limited to, reactive plasma-based deposition processes such as reactive ion plating, magnetron sputtering and ion-assisted electron beam evaporation as described, e.g., in U.S. Pat. Nos. 4,333,962, 4,448,802, 4,619,748, 5,211,759 and 5,229,570, each of which is incorporated by reference in its entirety herein. Optionally, and as is currently preferred, the selected coating application technique occurs in a vacuum.

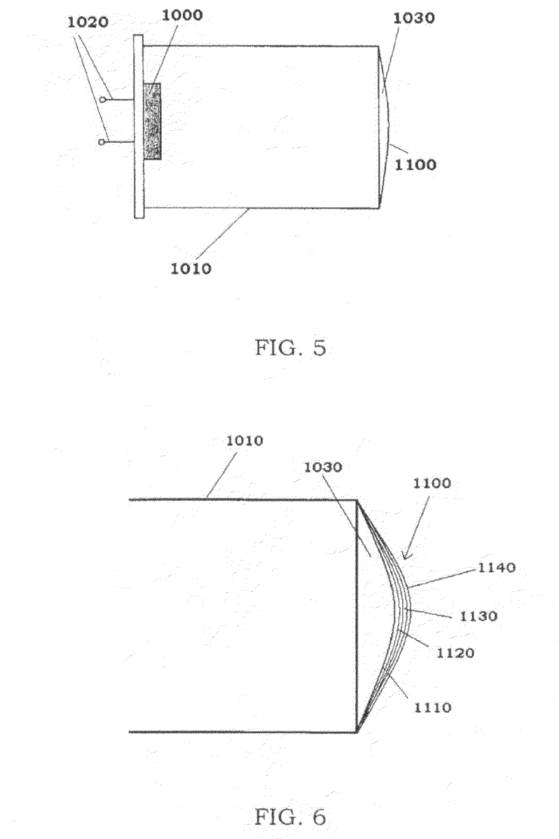

Referring to FIG. 5, an exemplary optoelectronic device 1000 is schematically shown. The term “optoelectronic device,” as used herein, refers to a device that is adapted to produce, emit, supply, absorb, detect, sense and/or manipulate light. Exemplary optoelectronic devices 1000 include, but are not limited to, light sources (e.g., one or more lamps, white light sources, light emitting diodes and/or semiconductor lasers) as well as light sensors/detectors such as one or more single element detectors (e.g., one or more photovoltaic diodes and/or a photoconductive detectors) or one or more two-dimensional detector arrays (e.g., one or more charge-coupled devices and/or charge-injection devices). Optoelectronic devices 1000 of the present application specifically include a light source 104 and a light sensor/detector 116 that are utilized as part of conventional fluorescence equipment, such as the fluorescence spectrometer 100 depicted in FIG. 1.

Optoelectronic devices in general, and the optoelectronic device 1000 depicted in FIG. 5 in particular, include a sealed housing 1010, electrical contacts 1020, and a transparent window 1030. Examples of housings 1010 having an optically transparent window 1030 include, but are not limited to, TO cans, such as a TO-5 can or a TO-52 can. As best shown in FIG. 6, it is the transparent window 1030 of the housing 1010 of an optoelectronic device 1000 on which a fluorescence coating 1100 can be formed as a plurality of thin film layers 1110, 1120, 1130, 1140.

It should be noted that although four coating layers 1110-1140 are shown in FIG. 6, the actual total number of coating layers present can be less than, or, as is currently preferred, can be either greater than or much greater than four total layers. Also, the material composition of adjoining layers of the coating 1100 generally, but not necessarily, is non-identical. For example, alternating layers of the coating 1100 can be formed from different materials, such that layer 1110 and layer 1130 are formed from an identical material or combination of materials, which is/are different that the material or combination of materials from which layers 1120 and 1140 are formed.

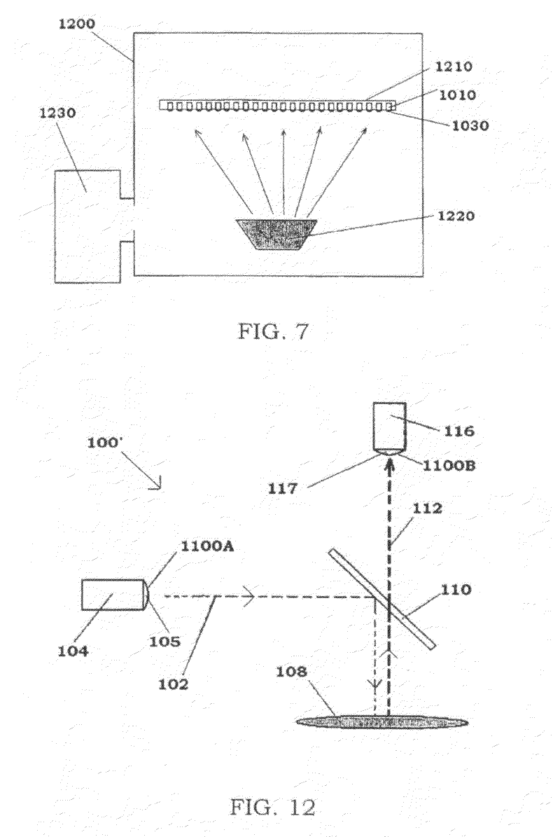

Referring now to FIG. 7, it schematically depicts an exemplary method for applying, depositing or otherwise placing the fluorescence coating 1100 onto a transparent window 1030 of the housing 1010 of one or more an optoelectronic device 1000. A containment structure (e.g., a vessel) 1200 includes one or more optoelectronic devices (not shown), each of which is contained within a housing 1010 which is placed within or is otherwise secured or held in place by one or more tools or fixtures 1210 such that the window 1030 of the housing faces one or more sources 1220 of the one or more fluorescence coating material(s) 1100 to be applied to the windows. A vacuum can be achieved within the vessel 1200, if desired, through use of an attached vacuum source 1230, which, by way of non-limiting example, can be one or more vacuum pumps. Using one of the aforementioned coating techniques, a stream of the vaporized coating material(s) (shown by arrows in FIG. 7) is directed from the one or more coating material sources 1220 and is caused to come into contact with each window 1030, thus forming a fluorescence coating thereupon.

As shown in FIG. 7, and is currently preferred, the vessel 1200 contains a plurality of optoelectronic device housings 1010, thus enabling a plurality of windows 1030 to be batch coated. This saves time and cost, and provides added assurance that the plurality of windows 1030 will be coated substantially identically, which may or may not occur if each window was coated individually instead.

Moreover, although only one fluorescence coating source 1220 is shown in FIG. 7, it is understood that there can be several such sources. The specific number of coating material sources 1220 included in the vessel 1200 depends on various factors; however, the number of coating material sources generally is equal to the number of different materials that comprise the coating 1100. For example, if the fluorescence coating is to be formed of two different materials, then generally there will be two separate coating material sources 1220, whereas generally there will be three separate coating material sources if the coating material is to be formed of three different materials. Also, the specific types of coating material sources 1220 that are included depends on factors such as the specific technique(s) utilized for applying the coating 1100 to the windows 1030.

### EXAMPLES

As a first example, an excitation-type fluorescence optical coating was formed on the window of the housing of a light emitting diode (LED) using a plasma-enhanced sputtering technique in accordance with FIG. 7. This exemplary coating is considered an excitation-type fluorescence coating because it is intended to eliminate the need to utilize an excitation optical filter, such as the excitation optical filter 106 in FIG. 1, in furtherance of a fluorescence technique, such as a technique that utilizes the fluorescence spectrometer 100 of FIG. 1. In particular, this exemplary excitation-type fluorescence coating was intended to replace an excitation optical filter 106 having a center wavelength of 535 nm.

Table 1 below indicates the specific layer-by layer formulation of this exemplary excitation-type fluorescence coating, wherein, the “first layer” of the coating is the layer that was deposited directly onto the window, and the “last layer” was the top layer of the coating that is exposed to air. In other words, the first layer was deposited directly onto the window, and layer 2 was deposited onto the first layer, and layers were further deposited onto each other until the “last layer” was deposited, onto which no additional layer was applied.

TABLE 1

| Layer | Material(s) | Thickness Characteristic |
|---|---|---|
| 1 (i.e., the first layer), 63, 65, 67, 69, 71, 73, | Niobium Oxide | 2 Optical Quarter Waves |
| 75, 77, 79, 85, 145 | and Titanium | at 535 nm |
| | Oxide | |
| 2, 6, 10, 14, 18, 22, 26, 30, 34, 38, 42, 46, 50, | Silicon Dioxide | 1 Optical Quarter Wave |
| 54, 58, 62, 64, 66, 68, 70, 72, 74, 76, 78, 80, | | at 535 nm |
| 82, 84, 86, 88, 90, 92, 94, 96, 98, 100, 102, | | |
| 104, 106,, 108, 110, 112, 114, 116, 118, 120, | | |
| 122, 124, 126, 128, 130, 132, 134, 136, 138, | | |
| 140, 142, 144, 146, 148, 150 | | |
| 3, 5, 7, 9, 11, 13, 15, 17, 19, 21, 23, 25, 27, | Niobium Oxide | 1 Optical Quarter Wave |
| 29, 31, 33, 35, 37, 39, 41, 43, 45, 47, 49, 51, | and Titanium | at 535 nm |
| 53, 55, 57, 59, 61, 81, 83, 87, 89, 91, 93, 97, | Oxide | |
| 99, 101, 103, 107, 109, 111, 113, 117, 119, | | |
| 121, 123, 127, 129, 131, 133, 137, 139, 141, | | |
| 143, 147, 149 | | |
| 4, 8, 12, 16, 20, 24, 28, 32, 36, 40, 44, 48, 52, | Silicon Dioxide | 2 Optical Quarter Wave |
| 56, 60 | | at 535 nm |
| 95, 105, 125, 135 | Niobium Oxide | 6 Optical Quarter Waves |
| | and Titanium | at 535 nm |
| | Oxide | |
| 115 | Niobium Oxide | 8 Optical Quarter Waves |
| | and Titanium | at 535 nm |
| | Oxide | |
| 151 | Niobium Oxide | 1.75 Optical Quarter |
| | and Titanium | Wave at 535 nm |
| | Oxide | |
| 152 (i.e., the “last layer”) | Silicon Dioxide | 0.75 Optical Quarter |
| | | Wave at 535 nm |

As a second example, an emission-type fluorescence optical coating was formed on the window of the housing of a photovoltaic diode using a plasma-enhanced sputtering technique in accordance with FIG. 7. This exemplary coating is considered an emission-type fluorescence coating because it is intended to eliminate the need to utilize an emission optical filter, such as the emission optical filter 114 in FIG. 1, in furtherance of a fluorescence measurement or detection technique, such as a technique that utilizes the fluorescence spectrometer 100 of FIG. 1. In particular, this exemplary fluorescence coating was intended to replace an emission optical filter 114 having a center wavelength of 607 nm.

Table 2 below indicates the specific layer-by-layer formulation of this exemplary emission-type fluorescence coating, wherein, the “first layer” of the coating is the layer that was deposited directly onto the window, and the “last layer” was the top layer of the coating that is exposed to air. In other words, the first layer was deposited directly onto the window, and layer 2 was deposited onto the first layer, and layers were further deposited onto each other until the “last layer” was deposited, onto which no additional layer was applied.

TABLE 2

| Layer | Material(s) | Thickness Characteristic |
|---|---|---|
| 1 (i.e., the first layer), 3, 5, 7, 9, 11, 13, 15, 17, | Tantalum | 1 Optical Quarter Waves |
| 19, 21, 23, 25, 27, 29, 31, 33, 35, 37, 39, 41, | Pentoxide | at 535 nm |
| 43, 45, 47, 49, 51, 53, 55, 57, 59, 61, 63, 65 | | |
| 2, 6, 62, 66 | Silicon Dioxide | 2 Optical Quarter Wave |
| | | at 535 nm |
| 4, 8, 12, 16, 20, 24, 28, 32, 36, 40, 44, 48, 52, | Silicon Dioxide | 1 Optical Quarter Wave |
| 56, 60, 64 | | at 535 nm |
| 10, 14, 18, 22, 26, 30, 34, 38, 42, 46, 50, 54, 58 | Silicon Dioxide | 4 Optical Quarter Waves |
| | | at 535 nm |
| 67 | Tantalum | 0.99342 Optical Quarter |
| | Pentoxide | Wave at 535 nm |
| 68 | Silicon Dioxide | 1.95074 Optical Quarter |
| | | Wave at 535 nm |
| 69 | Niobium Oxide | 1.78275 Optical Quarter |
| | and Titanium | Wave at 535 nm |
| | Oxide | |
| 70 | Silicon Dioxide | 1.51648 Optical Quarter |
| | | Wave at 535 nm |
| 71 | Niobium Oxide | 1.6425 Optical Quarter |
| | and Titanium | Wave at 535 nm |
| | Oxide | |
| 72 | Silicon Dioxide | 1.74427 Optical Quarter |
| | | Wave at 535 nm |
| 73, 75, 77, 79, 81, 83, 85, 87, 89, 91, 93, 95, | Niobium Oxide | 1.96581 Optical Quarter |
| 97, 99, 101 | and Titanium | Wave at 535 nm |
| | Oxide | |
| 74, 76, 78, 80, 82, 84, 86, 88, 90, 92, 94, 96, | Silicon Dioxide | 1.93406 Optical Quarter |
| 98, 100 | | Wave at 535 nm |
| 102 | Silicon Dioxide | 1.86015 Optical Quarter |
| | | Wave at 535 nm |
| 103 | Niobium Oxide | 0.05127 Optical Quarter |
| | and Titanium | Wave at 535 nm |
| | Oxide | |
| 104 | Silicon Dioxide | 1.9696 Optical Quarter |
| | | Wave at 535 nm |
| 105, 107, 109, 111, 113, 115, 117, 119, 121, | Niobium Oxide | 1.59722 Optical Quarter |
| 123, 125, 127, 129, 131, 133, 135, 137 | and Titanium | Wave at 535 nm |
| | Oxide | |
| 106, 108, 110, 112, 114, 116, 118, 120, 122, | Silicon Dioxide | 1.57142 Optical Quarter |
| 124, 126, 128, 130, 132, 134, 136 | | Wave at 535 nm |
| 138 | Silicon Dioxide | 1.40171 Optical Quarter |
| | | Wave at 535 nm |
| 139 | Niobium Oxide | 1.42249 Optical Quarter |
| | and Titanium | Wave at 535 nm |
| | Oxide | |
| 140 | Silicon Dioxide | 1.40376 Optical Quarter |
| | | Wave at 535 nm |
| 141, 143, 145, 147, 149, 151, 153, 155, 157, | Niobium Oxide | 1.3257 Optical Quarter |
| 159, 161, 163, 165, 167, 169 | and Titanium | Wave at 535 nm |
| | Oxide | |
| 142, 144, 146, 148, 150, 152, 154, 156, 158, | Silicon Dioxide | 1.32 Optical Quarter |
| 160, 162, 164, 166, 168 | | Wave at 535 nm |
| 170 | Silicon Dioxide | 1.62301 Optical Quarter |
| | | Wave at 535 nm |
| 171 | Niobium Oxide | 1.12592 Optical Quarter |
| | and Titanium | Wave at 535 nm |
| | Oxide | |
| 172 | Silicon Dioxide | 2.4977 Optical Quarter |
| | | Waves at 535 nm |
| 173 | Niobium Oxide | 0.52261 Optical Quarter |
| | and Titanium | Wave at 535 nm |
| | Oxide | |
| 174, 176, 178, 180, 182, 184, 186, 188, 190, | Silicon Dioxide | 0.74379 Optical Quarter |
| 192, 194, 196, 198, 200, 202, 204, 206, 208, | | Wave at 535 nm |
| 210, 212, 214 | | |
| 175, 177, 179, 181, 183, 185, 187, 189, 191, | Niobium Oxide | 0.72194 Optical Quarter |
| 193, 195, 197, 199, 201, 203, 205, 207, 209, | and Titanium | Wave at 535 nm |
| 211, 213 | Oxide | |
| 215 | Niobium Oxide | 0.49952 Optical Quarter |
| | and Titanium | Wave at 535 nm |
| | Oxide | |
| 216 | Silicon Dioxide | 0.93439 Optical Quarter |
| | | Wave at 535 nm |
| 217, 219, 221, 223, 225, 227, 229, 231, 233, | Niobium Oxide | 0.536 Optical Quarter |
| 235, 237, 239, 241, 243, 245, 247, 249, 251, | and Titanium | Wave at 535 nm |
| 253, 255, 257 | Oxide | |
| 218, 220, 222, 224, 226, 228, 230, 232, 234, | Silicon Dioxide | 0.598 Optical Quarter |
| 236, 238, 240, 242, 244, 246, 248, 250, 252, | | Wave at 535 nm |
| 254, 256 | | |
| 258 | Silicon Dioxide | 1.27111 Optical Quarter |
| | | Wave at 535 nm |

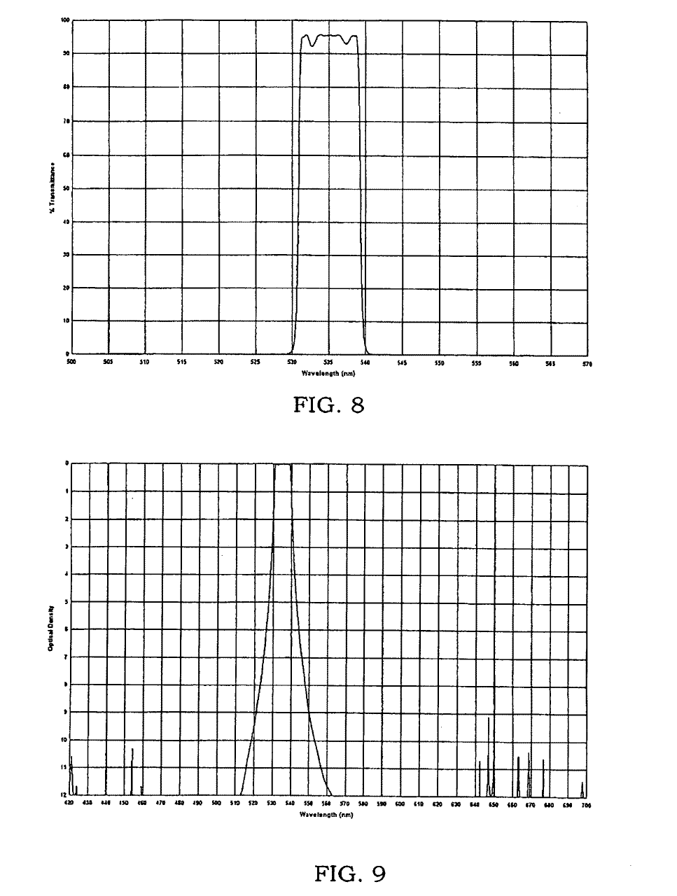

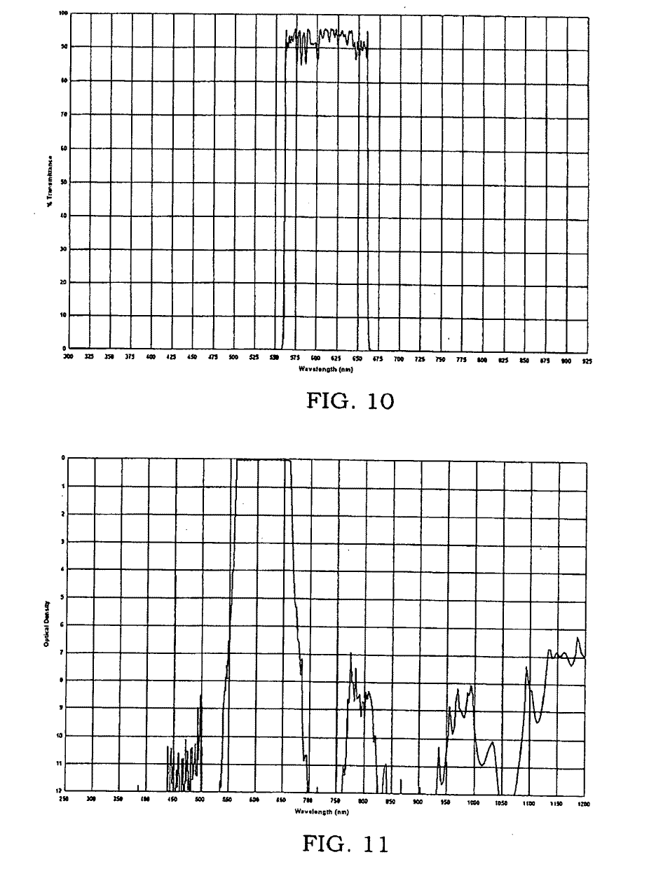

Referring now to FIGS. 8-11, they depict graphs representing the spectral performance of these two exemplary fluorescence coatings. FIG. 8 indicates that the exemplary excitation-type fluorescence coating substantially transmits light having a wavelength between about 530 nm and about 540 nm, and substantially blocks light having other wavelengths between at least about 500 nm and about 570 nm. Similarly, FIG. 10 indicates that the exemplary emission-type fluorescence coating substantially transmits light having a wavelength between about 560 nm and about 660 nm, and substantially blocks light having other wavelengths between at least about 300 nm and about 925 nm. Thus, such coatings would appear to mimic the performance, respectively, of an excitation optical filter (e.g., filter 106 in FIG. 1) having a center wavelength of about 535 nm and of an emission optical filter (e.g., filter 114 in FIG. 1) having a center wavelength of about 607 nm.

FIGS. 9 and 11 confirm, respectively, the light transmission and blocking capabilities of the exemplary excitation-type fluorescence coating and the exemplary emission-type coating. Specifically, FIG. 9 indicates that the optical density of the exemplary excitation-type fluorescence coating is zero within the range of about 530 nm to about 540 nm, and is at least 9 in the ranges of about 420 nm to about 520 nm and about 550 nm to at least 670 nm. FIG. 11 indicates that the optical density of the exemplary emission-type fluorescence coating is zero within the range of about 560 to about 660, is at least 7 within the range of about 250 nm to about 550 nm, and is at least 5 within the range of about 675 nm to about 1200 nm. Moreover, FIGS. 9 and 11 confirm that the exemplary excitation-type fluorescence coating and the exemplary emission-type fluorescence coating can be used in proximity (see FIG. 12, as discussed below) with little if any cross-talk, since the optical density of the exemplary excitation-type fluorescence coating is at least 9 within the entire range of about 550 nm to about 650 nm that is transmitted by the emission-type fluorescence coating, and since the optical density of the exemplary emission-type fluorescence coating is at least 11 within the entire range of about 530 nm to about 540 nm that is transmitted by the excitation-type fluorescence coating.

Therefore, FIGS. 8-11 demonstrate that the exemplary excitation-type fluorescence coating and the exemplary emission-type fluorescence coating serve the respective purposes of—and thus can eliminate the individual and/or collective need to include—the excitation and/or emission filters (e.g., filters 106, 114) that are generally used in furtherance of a fluorescence technique.

This provides several advantages, at least some of which are notable upon comparison of FIGS. 1 and 12. FIG. 12 depicts a fluorescence spectrometer 100′ that is identical to the fluorescence spectrometer 100 of FIG. 1 except that it does not include either the excitation optical filter 106 or the emission optical filter 114 of FIG. 1. These filters 106, 114 can be omitted in the FIG. 12 spectrometer 100′ by applying an excitation-type fluorescence coating 1100A of the present application to the window 105 of the light source 104 and by applying an emission-type fluorescence coating 1100B of the present application to the window 117 of the detector/sensor 116.

Alternatively, one, but not both, of the filters 106, 114 shown in the FIG. 1 spectrometer 100 can be omitted in the FIG. 12 spectrometer 100′ if instead the comparable fluorescence coating 1100A or 1100B is applied to the appropriate window 105 or 117.

Because the excitation and emission filters are not present in the fluorescence spectrometer 100′ of FIG. 12, the overall footprint occupied by the fluorescence spectrometer equipment is advantageously reduced, as is the total equipment cost. Moreover, the actual set up and operation of the equipment would be less exacting and time consuming if one or both of the filters 106, 114 was/were to be omitted as shown in FIG. 12. It should be noted that these advantages would occur for any fluorescence detection/measurement equipment that incorporates either or both of an excitation-type fluorescence coating and an emission-type fluorescence coating in lieu of one or both of an excitation optical filter and an emission optical filter, not just the fluorescence spectrometer 100′ of FIG. 8. Furthermore, as demonstrated by the data shown in the FIGS. 8-11 graphs, these advantages are not accompanied by any decrease in the ability of the fluorescence equipment to perform its detection and/or measurement functions, nor in the reliability of such detections and measurements.

Additionally, the exemplary excitation-type fluorescence coating and the exemplary emission-type fluorescence coating are beneficially hard and durable. This was verified by separately subjecting each of the exemplary fluorescence coatings to testing in accordance with military specification MIL-STD-810E. After 175 cycles, each lasting twenty-four hours, neither exemplary fluorescence coating appeared to have undergone any discernable physical or optical changes, let alone any would be expected to adversely affect the ability of the coatings to perform as intended. Thus, the fluorescence coating would have a usable lifetime comparable to, if not longer than the filter(s) 106, 114 they replace.

Although various aspects of the present application have been described herein with reference to details of currently preferred embodiments, it is not intended that such details be regarded as limiting the scope of the invention, except as and to the extent that they are included in the following claims—that is, the foregoing description of the embodiments of the optical filters of the present application are merely illustrative, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

1. An optoelectronic device having a housing, wherein the housing has an outer surface, and wherein at least a portion of the outer surface is coated with a coating, the coating comprising:
at least one layer of at least one thin film material, wherein the coating is effective to at least substantially replicate the performance of a predetermined fluorescence optical filter.

2. The optoelectronic device of claim 1, wherein the predetermined fluorescence optical filter is selected from the group consisting of an excitation optical filter and an emission optical filter.

3. The-optoelectronic device of claim 1, wherein the coating has a total layer thickness in the range of about 5 nm to about 10000 nm.

4. The optoelectronic device of claim 3, wherein each of the at least one layer of the coating has a thickness in the range of about 5 nm to about 1000 nm.

5. The optoelectronic device of claim 1, wherein the coating comprises a plurality of layers, and wherein a first of the plurality of layers is comprised of a first thin film material and a second of the plurality of layers is comprised of a second thin film material, and wherein the first thin film material is different than the second thin film material.

6. The optoelectronic device of claim 6, wherein the coating comprises a plurality of alternating layers of the first thin film material and the second thin film material.

7. The optoelectronic device of claim 1, wherein the coating comprises at least three layers, and wherein a first of the at least three layers is comprised of a first thin film material, a second of the at least three layers is comprised of a second thin film material, and a third of the at least three layers is comprised of a third thin film material, and wherein the first material is different than each of the second material and the third material, and wherein the second material is different than the third material.

8. The optoelectronic device of claim 1, wherein the coating comprises at least one layer that is comprised of a combination of at least two different thin film materials.

9. The optoelectronic device of claim 1, wherein each of the at least one thin film material is a metal oxide material.

10. The optoelectronic device of claim 9, wherein the metal oxide material is selected from the group consisting of:
(a) silicon dioxide;
(b) niobium oxide;
(c) titanium oxide;
(d) hafnium oxide;
(e) tantalum pentoxide; and
(f) a combination of at least two of (a), (b), (c), (d) and (e).

11. The optoelectronic device of claim 1, wherein the outer surface of the housing is a transparent window.

12. A fluorescence measurement or detection apparatus, comprising:
a light source having a housing, wherein the housing has an outer surface; and
a detector having a housing, wherein the housing has an outer surface,
at least one of the outer surface of the light source and the outer surface of the detector being at least partially coated with a coating comprised of at least one layer of at least one thin film material, wherein the coating is effective to at least substantially replicate the performance of a predetermined fluorescence optical filter.

13. The apparatus of claim 12, wherein the predetermined optical filter is selected from the group consisting of an excitation optical filter and an emission optical filter.

14. The apparatus of claim 13, wherein the outer surface of the housing of the light source is at least partially coated with a first coating comprised of at least one layer of at least one thin film material and the housing of the outer surface of the detector is at least partially coated with a second coating comprised of at least one layer of at least one thin film material, and wherein the first coating is effective to at least substantially replicate the performance of an excitation optical filter, and wherein the second coating is effective to at least substantially replicate the performance of an emission optical filter.

15. The apparatus of claim 12, wherein the coating has a total layer thickness in the range of about 5 nm to about 10000 nm.

16. The apparatus of 15, wherein the coating has a thickness in the range of about 5 nm to about 1000 nm.

17. The apparatus of claim 12, wherein the coating comprises a plurality of layers, and wherein a first of the plurality of layers is comprised of a first thin film material and a second of the plurality of layers is comprised of a second thin film material, and wherein the first thin film material is different than the second thin film material.

18. The optoelectronic device of claim 17, wherein the coating comprises a plurality of alternating layers of the first thin film material and the second thin film material.

19. The apparatus of claim 12, wherein the coating comprises at least three layers, and wherein a first of the at least three layers is comprised of a first thin film material, a second of the at least three layers is comprised of a second thin film material, and a third of the at least three layers is comprised of a third thin film material, and wherein the first material is different than each of the second material and the third material, and wherein the second material is different than the third material.

20. The apparatus of claim 12, wherein the coating comprises at least one layer that is comprised of a combination of at least two different thin film materials.

21. The apparatus of claim 12, wherein each of the at least one thin film material is a metal oxide material.

22. The apparatus of claim 21, wherein the metal oxide material is selected from the group consisting of:
(a) silicon dioxide;
(b) niobium oxide;
(c) titanium oxide;
(d) hafnium oxide;
(e) tantalum pentoxide; and
(f) a combination of at least two of (a), (b), (c), (d) and (e).

23. A coating, comprising:
at least one layer of at least one thin film material, wherein the coating is effective to at least substantially replicate the performance of a predetermined fluorescence optical filter.

24. The coating of claim 23, wherein the predetermined fluorescence optical filter is selected from the group consisting of an excitation optical filter and an emission optical filter.
